(19) United States
(12) Patent Application Publication
(10) Pub. No.: US 2005/0017951 A1
(43) Pub. Date: Jan. 27, 2005

(54) Optical cursor controller with an operating lens

(76) Inventors: Shuhai Lin, Shen-Tsun City (CN); Peichiu Chang, Taipei City (TW)

Correspondence Address: Supervisor, Patent Prosecution Services;PIPER RUDNICK LLP, 1200 Nineteenth Street, N.W., Washington, DC, 20036-2412, US

(21) Appl. No.: 10/623,608

(22) Filed: Jul. 22, 2003

(51) Int. Cl. G09G 5/08

(52) U.S. Cl. 345/166

(57) ABSTRACT

An optical cursor controller includes an operating lens, a light source, and a light processing unit. The operating lens permits movement of an object thereon. The light source radiates light that is directed to the operating lens and that is reflected by the object on the operating lens. The reflected light contains an image of the object on the operating lens. The light processing unit generates cursor control signals in accordance with detected movement of the image of the object on the operating lens.

### BACKGROUND OF THE INVENTION

1. Field of the Invention

The invention relates to an optical cursor controller, more particularly to an optical cursor controller with an operating lens that permits movement of an object thereon.

2. Description of the Related Art

A conventional optical mouse includes a housing, a light source, a converging lens, and a light processing unit. The housing has a lower side for moving on a mouse pad, and an upper side for grasping by one hand of the user. The lower side of the housing is formed with a light hole therethrough. The light source is mounted in the housing and is operable so as to radiate light that is directed to the light hole in the lower side of the housing. The light radiated by the light source is reflected by the mouse pad and contains an image of the mouse pad. The converging lens is mounted in the housing and converges the reflected light. The light processing unit is mounted in the housing, and includes an image sensor and an image processor. The image sensor, which is a charge-coupled device, receives the converged light. The image processor monitors the image of the mouse pad captured by the image sensor from the converged light to detect movement of the conventional optical mouse on the mouse pad, and generates cursor control signals in accordance with the detected movement. The cursor control signals are subsequently provided to an external device, such as a computer, to control position of a cursor on a display screen of a display module of the external device.

The aforesaid conventional optical mouse is disadvantageous in that it requires a relatively large space to operate upon, and that repetitive movement to operate the conventional optical mouse requires hand-intensive activities that can cause wrist strain injuries.

### SUMMARY OF THE INVENTION

Therefore, the object of the present invention is to provide an optical cursor controller that can overcome the aforesaid drawbacks of the prior art.

According to the present invention, an optical cursor controller comprises an operating lens, a light source, and a light processing unit. The operating lens has an operating surface that permits movement of an object thereon. The light source is operable so as to radiate light that is directed to the operating lens. The reflected light reflected by the object on the operating surface contains an image of the object on the operating surface. The light processing unit receives the reflected light, monitors the image of the object contained in the reflected light to detect movement of the object on the operating surface, and generates cursor control signals in accordance with detected movement of the object on the operating surface.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic partly cutaway view of the first preferred embodiment of an optical cursor controller according to the present invention;

FIG. 2 is a schematic view to illustrate an operating lens of the first preferred embodiment;

FIG. 3 is a block diagram illustrating a light processing unit and a peripheral controller of the first preferred embodiment;

FIG. 4 is a perspective view of the second preferred embodiment of an optical cursor controller according to the present invention; and

FIG. 5 is a perspective view of an electronic apparatus that is integrated with the third preferred embodiment of an optical cursor controller according to the present invention.

### DETAILED DESCRIPTION OF THE PREFERRED EMBODIMENTS

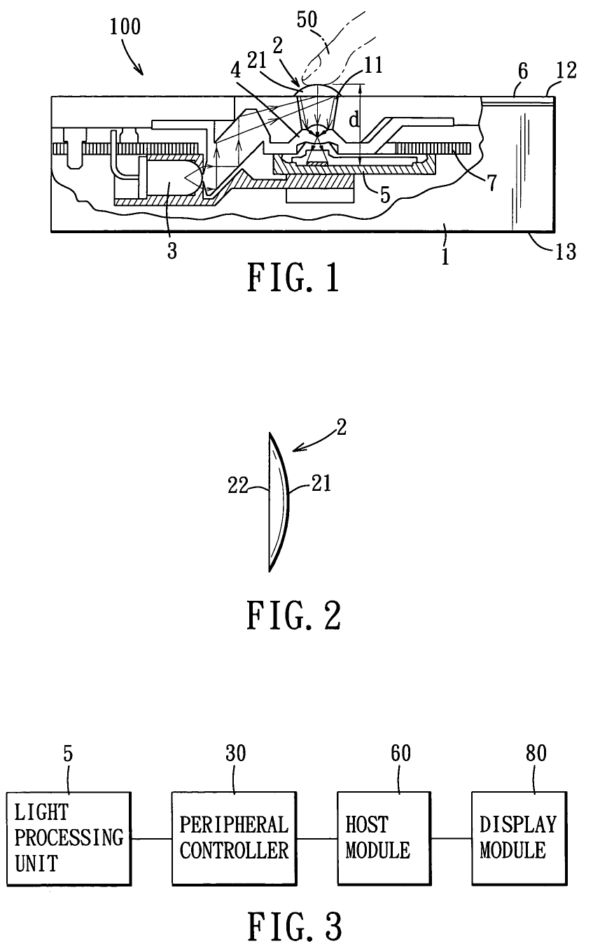

Referring to FIGS. 1 to 3, the first preferred embodiment of an optical cursor controller 100 according to this invention is shown to include a housing 1, an operating lens 2, a light source 3, and a light processing unit 5.

The optical cursor controller 100 is operably associated with a display module 80 for generating cursor control signals that control position of a cursor (not shown) on a display screen of the display module 80. The display module 80 is connected electrically to a host module 60 of a computer system. The display module 80 may be the display unit of one of a desktop computer, a notebook computer, a tablet personal computer, and a personal digital assistant.

The housing 1 is formed with a lens-mounting hole 11 therethrough. The lens-mounting hole 11 is confined by a hole-defining wall. The housing 1 has a lower side 13 adapted to be placed on a support (not shown), such as a table, and an upper side 12 adapted for placing a user's hand (not shown) thereon. The lens-mounting hole 11 is formed in the upper side 12 of the housing 1 at a position within reach of a finger 50 on the user's hand.

The operating lens 2 is mounted in the lens-mounting hole 11. In particular, the operating lens 2 has an operating surface 21 accessible from an exterior of the housing 1, an inner surface 22 that is opposite to the operating surface 21 and that faces an interior of the housing 1, and a periphery that interconnects the operating and inner surfaces 21, 22 and that is secured to the hole-defining wall. The operating surface 21 of the operating lens 2 permits movement of the finger 50 thereon. The operating lens 2 maybe a transparent glass, plastic, or resin. In this embodiment, the operating and inner surfaces 21, 22 of the operating lens 2 are convex and flat surfaces, respectively. The construction as such permits the operating lens 2 to create a magnifying effect.

The light source 3 is mounted in the housing 1 and is operable so as to radiate light that is directed to the operating lens 2. The radiated light undergoes refraction several times and then passes through the operating lens 2. At this time, when the finger 50 of the user is on the operating surface 21 of the operating lens 2, the radiated light is reflected by the finger 50 and thus contains an image of the finger 50. In this embodiment, the light source 3 includes a light emitting diode that radiates red light at a wavelength of 639 nm. In an alternative embodiment, the light source 3 includes a light emitting diode that radiates blue light at a wavelength of 875 nm.

The light processing unit 5 is mounted in the housing 1, and includes an image sensor (not shown) and an image processor (not shown). The image sensor receives the reflected light. In this embodiment, the image sensor has a frame rate of 1500 frames per second, and is in the form of a charge-coupled device (CCD). However, it should be apparent to those skilled in the art that a complementary metal-oxide semiconductor (CMOS) may be used as well. The image processor monitors the image of the finger 50 contained in the reflected light to detect movement of the finger 50 on the operating surface 21 of the operating lens 2, generates cursor control signals in accordance with detected movement of the finger 50 on the operating surface 21 of the operating lens 2, and includes an optical sensor, such as the ADNS-2051 optical sensor available from Agilent, and a digital signal processor (DSP).

The light source 3 and the light processing unit 5 are mounted on the same printed circuit board 7 to facilitate assembly.

The optical cursor controller 100 further comprises a converging lens 4 mounted in the housing land disposed between the operating lens 2 and the light processing unit 5 for converging the reflected light priorto receipt thereof by the light processing unit 5. Preferably, the converging lens 4 is implemented using the HDNS-2100 lens available from Agilent.

A peripheral controller 30 is connected electrically to the light processing unit 5. The peripheral controller 30 converts the cursor control signals generated by the light processing unit 5 into output signals that control the position of the cursor on the display screen of the display module 80. The output signals generated by the peripheral controller 30 are transmitted to the host module 60 of the computer system through a USB cable (not shown). Preferably, the peripheral controller 30 is implemented using a CY7C63723A-PC USB peripheral controller available from Cypress.

Although the peripheral controller 30 is exemplified using a USB peripheral controller, it should be apparent to those skilled in the art that a wireless peripheral controller (e.g. 802.11a, 802.11b, bluetooth, etc) may be used as well. As such, the cursor control signals generated by the light processing unit 5 can be transmitted to the host module 60 of the computer system wirelessly.

The optical cursor controller 100 further includes a mouse button unit 6 disposed on the upper side 12 of the housing 1. The mouse button unit 6 enables generation of mouse control signals, in a known manner, when operated.

It is noted that to obtain optimum focal length, the operating surface 21 of the operating lens 2 and the light processing unit 5 must be spaced apart at a distance (d) that ranges from 7.30 to 7.60 millimeters along an optical axis. The distance (d) is 7.45 millimeters in this embodiment.

Moreover, the magnifying effect of the operating lens 2 enhances sensitivity of the light processing unit 5 to the movement of the finger 50 on the operating surface 21 of the operating lens 2. In this embodiment, a good result is obtained when the operating lens 2 has a thickness not greater than 2 millimeters and a magnifying power ranging from 1 to 6 times.

Further, although the operating lens 2 is exemplified as having an inner surface that is flat and an operating surface that is convex, operating lenses of different shapes and sizes with different magnifying or reducing powers may be used as long as the object of this invention is achieved.

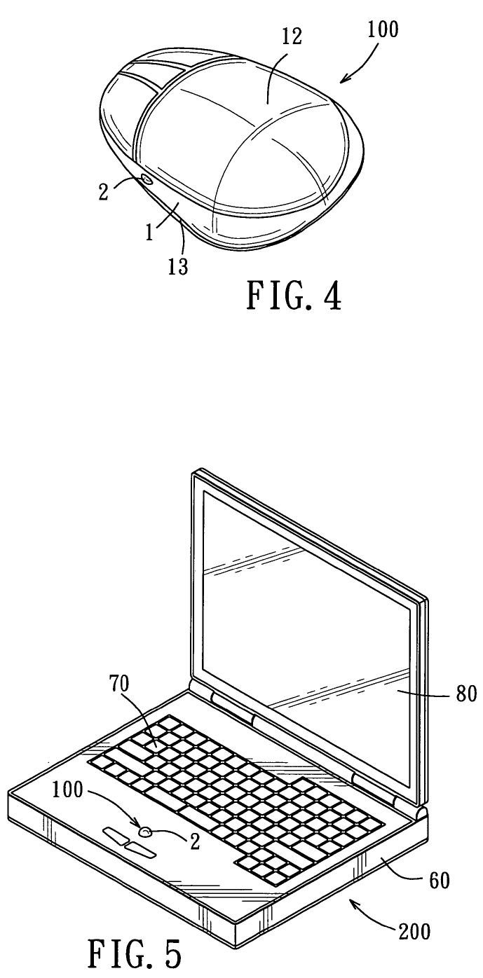

FIG. 4 shows the second preferred embodiment of an optical cursor controller 100 according to the present invention. This embodiment differs from the previous embodiment simply in that the operating lens 2 is mounted in a lateral part of the upper side 12 of the housing 1 so as to be accessible by the thumb (not shown) of the user's hand.

FIG. 5 shows the third preferred embodiment of an optical cursor controller 100 according to the present invention. In this embodiment, the optical cursor controller 100 is integrated into an electronic apparatus 200, such as a notebook computer.

The electronic apparatus 200 includes a display module 80 with a display screen, and a host module 60 connected pivotally and electrically to the display module 80 and provided with a keyboard 70 thereon. The optical cursor controller 100 is mounted on the host module 60 such that the operating surface of the operating lens 2 is accessible from an exterior of the host module 60. In other words, the host module 60 serves as the housing of the optical cursor controller 100 in this embodiment.

It has thus been shown that the optical cursor controller 100 of the present invention includes an operating lens 2 that permits movement of a finger 50 on a user's hand thereon, a light source 3 that is used to generate reflected light containing an image of the finger 50, and a light processing unit 5 that generates cursor control signals in accordance with detected movement of the image of the finger 50 on the operating lens 2. The arrangement as such allows the user to control the position of a cursor on the display screen of the display module 80 without moving the optical cursor controller 100. In other words, the user simply needs to move his finger 50 on the operating lens 2 for cursor control. As such, unlike the conventional optical mouse, the optical cursor controller 100 of this invention remains stationary and does not require a relatively large space to operate upon. Moreover, since the optical cursor controller 100 of this invention does not need to be moved repeatedly, wrist strain injury can be avoided during use. Further, the components in the conventional optical mouse, with the addition of the operating lens 2, can be employed to implement the optical cursor controller 100 of this invention.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

1. An optical cursor controller comprising:
an operating lens having an operating surface that permits movement of an object thereon;
a light source operable so as to radiate light that is directed to said operating lens, wherein reflected light reflected by the object on said operating surface contains an image of the object on said operating surface; and
a light processing unit for receiving the reflected light, monitoring the image of the object contained in the reflected light to detect movement of the object on said operating surface, and generating cursor control signals in accordance with detected movement of the object on said operating surface.

2. The optical cursor controller as claimed in claim 1, further comprising a converging lens disposed between said operating lens and said light processing unit for converging the reflected light prior to receipt by said light processing unit.

3. The optical cursor controller as claimed in claim 1, wherein said operating surface of said operating lens is a convex surface.

4. The optical cursor controller as claimed in claim 1, wherein said operating lens has a magnifying power ranging from 1 to 6 times.

5. The optical cursor controller as claimed in claim 1, wherein said operating lens has a thickness not greater than 2 millimeters.

6. The optical cursor controller as claimed in claim 1, wherein said light source includes a light emitting diode.

7. The optical cursor controller as claimed in claim 1, wherein said operating surface of said operating lens and said light processing unit are spaced apart from each other at a distance ranging from 7.30 to 7.60 millimeters along an optical axis.

8. An optical cursor controller comprising:
a housing formed with a lens-mounting hole therethrough;
an operating lens mounted in said lens-mounting hole and having an operating surface accessible from an exterior of said housing, said operating surface permitting movement of an object thereon;
a light source mounted in said housing and operable so as to radiate light that is directed to said operating lens, wherein reflected light reflected by the object on said operating surface contains an image of the object on said operating surface; and
a light processing unit mounted in said housing, receiving the reflected light, monitoring the image of the object contained in the reflected light to detect movement of the object on said operating surface, and generating cursor control signals in accordance with detected movement of the object on said operating surface.

9. The optical cursor controller as claimed in claim 8, wherein said housing has a lower side adapted to be placed on a support, and an upper side adapted for placing a user's hand thereon, said lens-mounting hole being formed in said upper side at a position within reach of a finger on the user's hand.

10. The optical cursor controller as claimed in claim 8, further comprising a converging lens mounted in said housing and disposed between said operating lens and said light processing unit for converging the reflected light prior to receipt by said light processing unit.

11. The optical cursor controller as claimed in claim 8, wherein said operating surface of said operating lens is a convex surface.

12. The optical cursor controller as claimed in claim 8, wherein said operating lens has a magnifying power ranging from 1 to 6 times.

13. The optical cursor controller as claimed in claim 8, wherein said operating lens has a thickness not greater than 2 millimeters.

14. The optical cursor controller as claimed in claim 8, wherein said light source includes a light emitting diode.

15. The optical cursor controller as claimed in claim 8, wherein said operating surface of said operating lens and said light processing unit are spaced apart from each other at a distance ranging from 7.30 to 7.60 millimeters along an optical axis.

16. An electronic apparatus comprising a display module with a display screen, and an optical cursor controller operably associated with said display module for generating cursor control signals that control position of a cursor on said display screen of said display module, wherein said optical cursor controller includes:
an operating lens having an operating surface that permits movement of an object thereon;
a light source operable so as to radiate light that is directed to said operating lens, wherein reflected light reflected by the object on said operating surface contains an image of the object on said operating surface; and
a light processing unit for receiving the reflected light, monitoring the image of the object contained in the reflected light to detect movement of the object on said operating surface, and generating the cursor control signals in accordance with detected movement of the object on said operating surface.

17. The electronic apparatus as claimed in claim 16, further comprising a host module connected to said display module and provided with a keyboard thereon, said optical cursor controller being mounted on said host module such that said operating surface of said operating lens is accessible from an exterior of said host module.
